(19) United States
(12) Patent Application Publication
(10) Pub. No.: US 2014/0205446 A1
(43) Pub. Date: Jul. 24, 2014

(54) REGULATED OIL COOLING SYSTEM FOR A TURBINE ENGINE WITH DEICING OF THE NACELLE

(71) Applicant: SNECMA, Paris (FR)

(72) Inventors: Emmanuel PATSOURIS, Melun (FR); Lambert Demoulin, Paris (FR)

(73) Assignee: SNECMA, Paris (FR)

(21) Appl. No.: 14/161,296

(22) Filed: Jan. 22, 2014

(30) Foreign Application Priority Data
Jan. 22, 2013 (FR) 13 50559

(51) Int. Cl. F02C 7/14; F02C 7/047

(52) U.S. Cl. CPC F02C 7/14; F02C 7/047
USPC 415/175

(57) ABSTRACT

The invention relates to an oil cooling system of a turbine engine installed in an aircraft comprising a circuit suitable for circulating the oil between the engine and at least one external heat exchanger placing the oil in thermal communication with a part of the lip of the nacelle, wherein it also comprises at least one air/oil heat exchanger placing the oil in thermal communication with the air circulating in the cold zone of the turbine engine, equipped with a device suitable for varying its oil cooling capacity, and with a control means for said cooling capacity variation device.

### BACKGROUND OF THE INVENTION

The present invention relates to the field of the integration of turbine engines with which aircraft are equipped. It relates more particularly to the design of the lubrication system linked to the anti-icing system on aerodynamic elements such as the engine nacelle.

### DESCRIPTION OF THE PRIOR ART

The thermal power to be discharged with the oil on turbine engines is constantly increasing, notably those equipped with a fan driven by a reducing gear. Furthermore, this has to be done with strong bulk constraints. In practice, on a turbine engine equipped with a mechanical transmission box situated around the propulsive core, represented in FIG. 1, most of the equipment is installed in the hot zone (3) around the engine compartments of restricted diameter comprising the combustion chamber and the compressor and the high pressure turbine, instead of the cold zone (2) of the fan compartment. This makes it possible to reduce the diameter of the nacelle and enhance the aerodynamic efficiency. On the other hand, such equipment is subject to significant thermal stresses which reheat the lubrication oil all the more.

Moreover, when the engine encounters icing conditions during the flight, the upstream part of the engine nacelle (5), called the inlet lip (4), like other exposed elements (turbine engine entry cone or leading edges of the wings) has to be reheated to prevent the ice from forming on its outer surface and avoid reducing the aerodynamic efficiency.

The use of oil to deice the front cone of an airplane turbine engine (EP 1 965 040) is known. This usage is also known for deicing the air inlet lip of a nacelle (CA 2 471 259). The latter document also proposes:
mitigating a leak brought about by damage to this exchanger by a regulation means on the cooling circuit
limiting the volume of oil needed to place the oil in contact with the large surface of the lip by the use of pipe coils.

However, although the optimization of the heat exchange device has been studied, the problem of regulating the system according to operational conditions (flight, take-off, taxiing phase) remains. In practice, if a large surface area, accordingly increasing its vulnerability, is not devoted to this exchanger placed on the lip, it will be insufficient to cool the oil of the engine in the take-off and taxiing phases.

Air/oil surface exchangers with adjustable scoop (EP 2 472 067) are known for modulating the heat exchange according to operational conditions. However, this document recommends distributing these modulable exchangers over the aerodynamic surface to be cooled.

This presents the disadvantage of installing complex systems on a large surface. Furthermore, this surface is exposed to impacts, notably with birds, as noted in the document CA 2 471 259. The damage to such exchangers can cause the capacity to regulate the cooling system to be lost first.

In all cases, the existing solutions necessitate, for safety reasons, maintaining an overdimensioned cooling system with consequences on the bulk and the resulting aerodynamic losses.

### SUMMARY OF THE INVENTION

The object of the present invention is to produce a system combining the cooling of the oil of the turbine engine and the de-icing of the air inlet, by optimizing the de-icing function and the bulk of the oil cooling system.

To this end, it relates to an assembly comprising a bypass turbine engine, a nacelle in which said turbine engine is installed, and an oil cooling system comprising a circuit suitable for circulating the oil between the engine and at least one external heat exchanger consisting of oil pipelines of small diameter in contact with a metal skin constituting the surface of at least a part of the lip of the nacelle, wherein it also comprises at least one air/oil heat exchanger placing the oil in thermal communication with the air circulating in the bypass air stream of the turbine engine, equipped with a device suitable for varying its oil cooling capacity, and with a control means for said cooling capacity variation device.

The solution achieves its objective in particular through the combination of the two exchangers in order to create a reliable system in all areas of flight, which eliminates almost all the aerodynamic losses associated with the cooling of the oil and which optimizes the efficiency over a large portion of the flight.

Notably, the efficiency of the external exchanger with small pipelines makes it possible to limit the aerodynamic losses associated with the air/oil exchanger in the cold zone of the engine during the cruising flight phases by stressing it little or not at all.

In a turbine engine according to the prior art without speed reducing gears for driving the fan, the head losses due to the heat exchangers in the bypass air flow correspond to 0.31% of the total, or a cost of 0.42% in the specific consumption of the turbine engine. The reducing gears that have to drive the fan in the planned new turbine engine architectures have to dissipate two to three times more heat. The external exchanger distributing small pipelines over the lip of the nacelle is capable of discharging this heat. Since the aerodynamic losses with the traditional exchangers are substantially proportional to the heat flux to be discharged, the use of the invention therefore represents a saving of 1% to 1.5% in consumption in cruising phase, based on the preceding data. This saving is therefore significant for an airplane engine.

Furthermore, the use of an air/oil exchanger situated in the bypass air flow with a variable capacity makes it possible to dimension the external exchanger for the flight conditions where the aerodynamic gain is most advantageous, while having the resource to correctly cool the oil with this second exchanger in the other conditions, for example during take-off and when taxiing.

Moreover, the efficiency of the external exchanger with small pipelines makes it possible to limit the quantity of oil in the lubrication circuit and to accordingly reduce the size of the pumps for circulating it.

For the air/oil heat exchanger, in the bypass air flow of the cold part, use will preferentially be made of an air tapping scoop for tapping air from the cold zone flow, the geometry of which is variable. In particular, this scoop can completely close the supply opening of the air/oil heat exchanger. Thus, the air/oil heat exchanger does not create head losses in the bypass flow when it is not functioning.

It is also advantageous to use a large scoop surface when the capacity of the air/oil heat exchanger has to be at maximum, which makes it possible to minimize its size, and therefore the disturbances that it creates in the air flow.

Advantageously, the external heat exchanger has sufficient cooling capacity to ensure on its own the temperature regulation of the oil in cruising flight conditions. This makes it possible to close the scoop of the second exchanger and therefore to optimize the aerodynamic efficiency of the engine by eliminating the air tapping when this exchanger is not of use.

Preferentially, the external heat exchanger is placed in series with the air/oil heat exchanger, more particularly after the tank.

To regulate the temperature of the oil, the section of the variable-geometry scoop is varied. It is thus possible to maintain an overall constant cooling efficiency even when the efficiency of the exchanger on the lip varies with the temperature. Advantageously, it is the measurement of this overall efficiency which is used to control the variation of the section of the scoop.

Preferentially, a pressure sensor is placed on the part of the circuit at the inlet of the external heat exchanger as well as a bypass circuit with a valve capable of isolating this heat exchanger. The air/oil heat exchanger which serves as a backup in this case is situated in a portion of the flow protected from external impacts.

In this way, a simple and reliable system ensures that damage to the external heat exchanger does not result in the complete loss of the lubrication system.

### BRIEF DESCRIPTION OF THE DRAWINGS

The operation and the advantages of the invention will emerge from the detailed description of its implementation on a turbine engine, with reference to the appended drawings in which:

FIG. 1 represents the zones of a turbine engine affected by the invention,

FIG. 2 represents a system according to the prior art,

FIG. 3 represents an oil cooling system according to the invention,

FIG. 4 represents a schematic diagram of a heat exchanger with variable scoop,

FIG. 5 represents a detail of the heat exchange device on the nacelle.

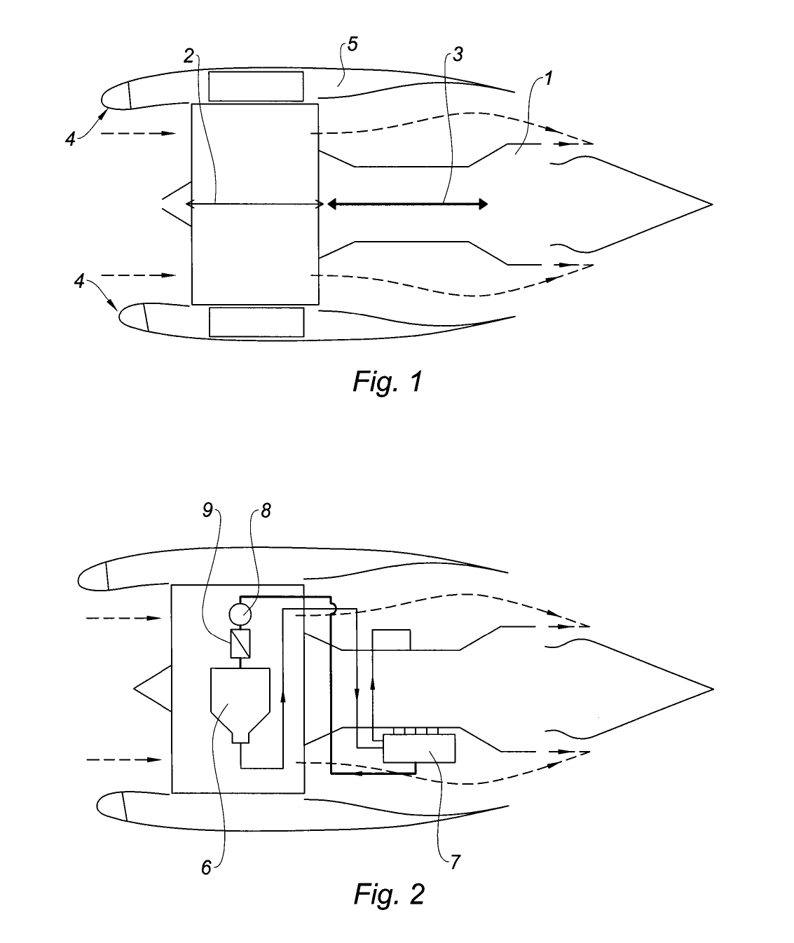

A cooling circuit according to the prior art operates in the manner described below, corresponding to FIG. 2.

A lubrication set (7), comprising all the mechanisms activating and directing the oil in the cooling circuit, is placed as close as possible to the turbine engine, in the hot zone. This lubrication set pumps the oil stored in a tank (6) installed in the cold zone and sends it into the turbine engine (1) to ensure the lubrication of the engine components, such as the rolling bearings and gears.

The lubrication set (7) uses a series of pump to suck the oil passed into the turbine engine and send it to heat exchangers situated in the cold zone. A first type of exchanger (8) uses the heat of the oil to reheat the fuel so that it does not freeze. Also, one or more air/oil exchangers (9) cool the oil in contact with the air flow in the cold zone, preferably the bypass flow in the fan for the bypass turbine engines, and ensure the regulation of the oil temperature for its use in the engine. These exchangers can in particular be placed in the bypass air stream behind the fan. On leaving the exchangers, the oil is returned to the tank.

### Description of the Preferred Embodiment

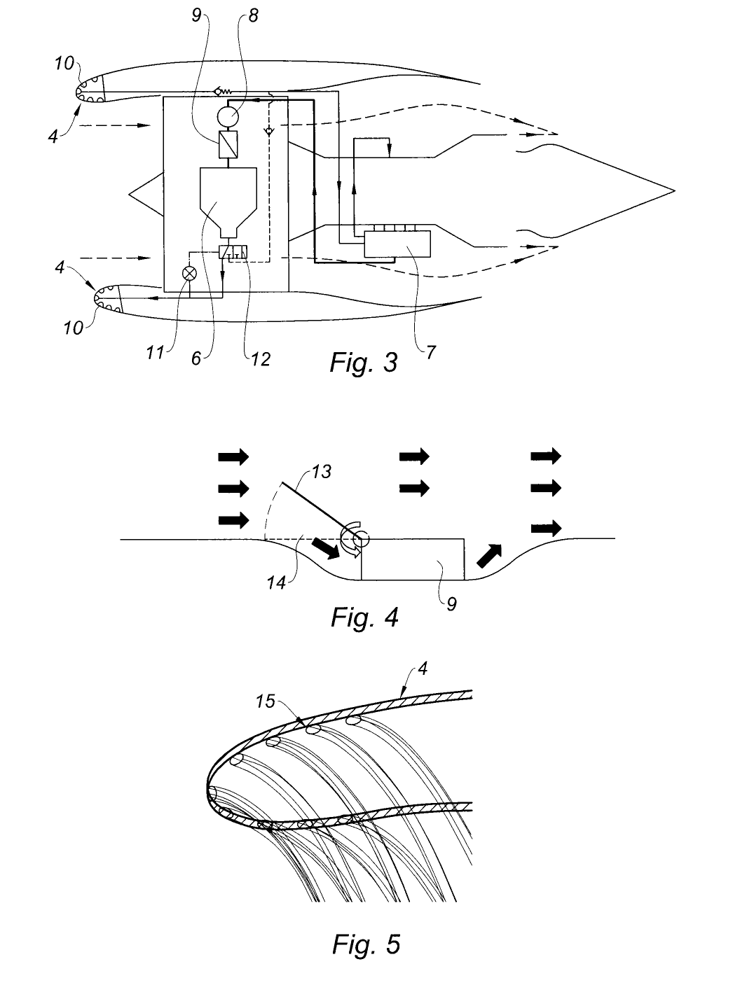

According to a preferential embodiment of the invention, as presented in principle in FIG. 3, the main differences compared to the prior art lie in the addition of a circuit sending the oil to a device (10), forming an external heat exchanger between the oil and the air inlet lip, and in the adaptation of the air/oil exchanger (9) in order to equip it with a device for varying its cooling capacity, with a control means for said device. Preferentially, the circuit comprising the external heat exchanger (10) is situated between the tank and the engine, therefore in series after the air/oil heat exchangers (9) situated in the cold zone. This arrangement makes it possible to limit the design modifications of the cooling circuit on an existing engine, notably without adding pumps in addition to those of the lubrication set (7) for sucking the oil into the external heat exchanger.

This heat exchanger (10) on the lip of the nacelle (5) fulfills two functions:
it makes it possible to reheat the lip (4) of the nacelle (5) and therefore serves as an anti-icing device, avoiding the need for recourse to devices requiring an additional energy source (heating resistors, pneumatic boots) or that penalize the operation of the engine (tapping hot air from the hot zones);
it participates in the oil temperature regulation function and makes it possible to reduce the dimensioning of the air/oil exchangers (9) in the cold zone.

Several ways are known for producing an oil heat exchanger with the upstream parts of aerodynamic elements exposed to icing on the airplane, such as the air inlet lip (4) of the nacelle (5), the upstream cone of the jet engine, the leading edges of the bypass flow separators in the fan stage, or even the leading edges of a wing. A preferred embodiment for implementing the invention, illustrated in FIG. 5, consists in using small pipelines (15) distributed over the ice prevention zone. These pipelines are in contact with the metal skin forming the lip (4) of the nacelle (5), by its internal surface, as is represented in FIG. 5. The conductivity of the material of the lip is then used to uniformly distribute the heat conveyed by the oil and thus de-ice the outer surface. The diameter of the section of the pipelines is small compared to the magnitudes characterizing the area of the lip affected by the heat exchanges. This diameter is in fact of a size comparable to the width of skin influenced by conductivity around the pipeline.

Advantageously, this configuration reduces the additional quantity of oil needed because of the large surface area to be covered to cool the lip (4) of the nacelle (5). Secondarily, this device can also be installed on the leading edge of other, similar aerodynamic elements external to the turbine engine, like the leading aerodynamic profile edges.

The strong variations of the efficiency for the cooling of the oil in this external exchanger as a function of the operational conditions require the use of at least one additional heat exchanger. In practice, when the airplane is on the ground, in particular in hot regions, the inlet lip is less effective for cooling the oil while the engine continues to reheat it during the taxiing and take-off phases. This is particularly true for a bypass turbine engine with a gearbox driving the fan which greatly increases the temperature of the lubricant during these phases because it is stressed. On the other hand, in cruising flight conditions, it is possible to dimension it to ensure both the de-icing and the cooling of the oil. It is therefore not optimal to dimension this exchanger to cover the cooling function in all operational conditions.

On the other hand, its presence makes it possible to significantly reduce the dimensioning of the air/oil exchanger or exchangers (9) in the cold zone (3). The air/oil exchanger (9) is dimensioned to have maximum cooling capacity in operational phases when the exchanger (10) situated on the lip (4) of the nacelle (5) is least effective. Given the engine operating characteristics during these phases, this nevertheless reduces the dimensioning of the air/oil exchanger (9) compared to the prior art.

This air/oil exchanger (9) operates, as is represented in FIG. 4, by tapping a part of the bypass air flow through an opening (14) in the wall where it is installed. Its bulk is inversely proportional to the air flow passing through it. A preferential embodiment therefore uses a maximum opening (14) compatible with the installation constraints.

The combination of the two types of exchangers, each dimensioned for particular operational conditions, offers, in certain flight phases, an excessive cooling capacity to the detriment of the aircraft performance levels, notably because of the tapping of air through the opening (14). It is therefore advantageous to regulate it.

The means for regulating the cooling of the oil according to the operational conditions is obtained according to the invention by providing the air/oil exchanger with an exchange coefficient that can vary with the air flow passing through the cold zone.

A number of ways are known for producing an air/oil exchanger (9) with variable cooling capacity. In a preferential embodiment, an air/oil exchanger as described previously is used and it is equipped with a scoop (13) which regulates the flow rate of this tapped flow by varying the distance between it and the opening (14).

A control means for the means for varying the cooling capacity of the air/oil exchanger (9) complements the regulation of the oil cooling system. The operation of this control means is simple by virtue of the series installation of the exchangers because it simply has to control the efficiency of the air/oil exchanger (9) according to the observed efficiency of the cooling system as a whole without having to interact with the lubrication set (7) or activate valves. Preferentially, the control means is not installed in the hot zone and a temperature measurement in the tank (6) serves to assess the overall efficiency of the cooling system.

For an air/oil exchanger (9) as described in FIG. 4, the aerodynamic losses generated are proportional to the tapped air flow rate. In a preferred embodiment, the nacelle lip exchanger (10) is dimensioned to ensure, on its own, the cooling of the oil in at least certain flight phases. Then, the control device can close the scoop of the exchanger, which makes it possible to cancel the aerodynamic losses due to tapping of air.

The implementation of the invention therefore makes it possible to optimize the components of the oil cooling system which will preferentially be done in two steps. Firstly, the heat exchanger (10) of the lip of the nacelle is dimensioned so as to both eliminate the de-icing equipment of the nacelle (5) involving additional energy sources and to ensure the temperature regulation of the oil during the cruising flight conditions of the aircraft. Then, the air/oil exchanger is dimensioned with its scoop to minimize the bulk in the cold zone and reduce, or even eliminate, all the tappings of air to cool the oil in the majority of the flight phases.

Finally, this device minimizes the risks in the event of impact of the nacelle (5) with a bird, for example. In case of damage of this type, the oil must continue to ensure its role even if the cooling circuit installed is damaged or broken. It should be noted that this risk mainly affects the exchanger (10) placed on the air inlet lip (4) of the nacelle (5), the part of the circuit notably comprising the tank (6) and the exchanger (9), situated in the cold zone of the turbine engine is protected. In an embodiment suited to this eventuality, a bypass means, represented in FIG. 3, is installed at the outlet of the tank. It comprises a pressure sensor (11), placed between the tank and the heat exchanger (10) of the air inlet lip, a bypass circuit making it possible to directly return the oil from the tank to the lubrication set (7) and a distribution valve (11) between this bypass circuit and the supply for the exchanger (10). When the sensor (11) detects a significant pressure variation in the branch going to the exchanger (10), it sends a signal to the distribution valve (11) which directs all the oil flow directly to the lubrication set (7). In this way, the lubrication of the engine is never interrupted.

1. An assembly comprising a bypass turbine engine, a nacelle in which said turbine engine is installed, and an oil cooling system for said turbine engine comprising a circuit suitable for circulating the oil between the engine and at least one external heat exchanger consisting of oil pipelines of small diameter in contact with a metal skin constituting the surface of at least a part of the lip of the nacelle, wherein it also comprises at least one air/oil heat exchanger placing the oil in thermal communication with the air circulating in the bypass air stream of the turbine engine, equipped with a device suitable for varying its oil cooling capacity, and with a control means for said cooling capacity variation device.

2. The assembly as claimed in claim 1, in which the cooling capacity variation device is a tapping scoop with variable geometry, for tapping air from the cold zone flow.

3. The assembly as claimed in claim 2, in which the tapping scoop can completely close the opening supplying the air/oil exchanger.

4. The assembly as claimed in claim 1, in which the external exchanger has sufficient cooling capacity to ensure on its own the temperature regulation of the oil in cruising flight conditions.

5. The assembly as claimed in claim 1, in which the external heat exchanger is placed in series with the air/oil heat exchanger.

6. The assembly as claimed in claim 1, in which the control means of the device for varying the cooling efficiency of the air/oil heat exchanger comprises a means for measuring the overall efficiency of said oil cooling system.

7. The assembly as claimed in claim 1, comprising a pressure sensor on the part of the oil circuit at the inlet of the external heat exchanger and a bypass circuit with a valve capable of isolating said external heat exchanger.
